(19) United States
(12) Patent Application Publication
(10) Pub. No.: US 2025/0321900 A1
(43) Pub. Date: Oct. 16, 2025

(54) MULTIPLE DISTRUSTING EXTERNAL WORKLOADS

(71) Applicant: QUALCOMM Incorporated, San Diego, CA (US)

(72) Inventors: Jeremy Robin Christopher O'DONOGHUE, Wokingham (GB); Aymeric VIAL, Antibes (FR); Eckhard DELFS, Nürnberg (DE); David HARTLEY, Berlin (DE)

(21) Appl. No.: 19/065,847

(22) Filed: Feb. 27, 2025

Related U.S. Application Data
(60) Provisional application No. 63/634,319, filed on Apr. 15, 2024.
(60) Provisional application No. 63/634,318, filed on Apr. 15, 2024.
(60) Provisional application No. 63/634,305, filed on Apr. 15, 2024.
(60) Provisional application No. 63/634,300, filed on Apr. 15, 2024.

(51) Int. Cl. G06F 12/14; G06F 21/62

(52) U.S. Cl. CPC G06F 12/1416; G06F 21/6218; G06F 2212/1052

(57) ABSTRACT

Certain aspects provide a method for processing an operation by a first processor. According to certain aspects, the method generally includes obtaining information indicating an operation relates to an external workload of a plurality of external workloads supported by the first processor; and processing the operation based on the information.

### CROSS-REFERENCE TO RELATED APPLICATION

This application claims benefit of and priority to U.S. Provisional Patent Application Nos. 63/634,300, 63/634,305, 63/634,318, and 63/634,319, all filed Apr. 15, 2024 and hereby incorporated by reference in their entirety.

### BACKGROUND

### Field of the Disclosure

Aspects of the present disclosure relate to techniques for memory management and shared access in a computing environment.

### Description of Related Art

Partitioning operations of a processor in computing systems may be performed to achieve security, isolation, and controlled execution environments. This can be implemented using several mechanisms, primarily for purposes such as security, virtualization, and fault tolerance.

The partitioning may ensure that different processes or applications running on the processor are isolated from one another, which may be vital for security reasons. For example, if one process is compromised (e.g., through a buffer overflow or malware), it should not be able to access or manipulate other processes' data, or underlying hardware.

The partitioning may help contain faults to a specific domain or process, preventing them from spreading across an entire system. For example, if a particular process or virtual machine crashes, the rest of the system remains unaffected. This is especially important for systems where uptime and reliability are critical, such as real-time applications.

The partitioning may ensure that the processor and other resources are allocated effectively and fairly among different tasks or users. For example, in cloud hosting, a hypervisor allocates processor resources to different virtual machines running on a same physical server, ensuring fair performance and preventing one virtual machine from consuming all the resources.

Virtualization involves creating multiple virtual machines on a single physical processor, where each virtual machine operates in its own isolated environment. This partitioning is managed by a layer called a hypervisor. The hypervisor sits between a physical hardware and the virtual machines, ensuring that each virtual machine gets its own allocation of the processor, memory, and storage, while isolating them from each other. Virtual machine are unable to interfere with one another directly, even if they are running on the same physical machine. This creates mutually distrustful environments, as each virtual machine believes it has its own dedicated hardware.

In typical virtualization architectures, the virtual machines are not isolated from the hypervisor. For some security/privacy use cases such as confidential computing it is beneficial to have some virtual machines running on the same processor that are isolated and protected from the hypervisor, creating a further level of security domain called a world in some processor architectures. Virtual machines that are not isolated from the hypervisor are in the “normal” world while isolated virtual machines run in another world.

Memory protection mechanisms enforce boundaries between different parts of a memory associated with the processor, ensuring that one program cannot access or corrupt the memory of another program or the kernel. A memory management unit (MMU) in the processor translates virtual addresses to physical addresses and ensures that programs running in user mode cannot directly access memory allocated to other programs or the kernel. One or more memory isolation techniques help partition execution into independent, mutually distrusting domains.

### SUMMARY

One aspect provides a method by a processor. The method includes obtaining information indicating an operation relates to an external workload of a plurality of external workloads supported by the processor; and processing the operation based on the information.

Another aspect provides a method by a processor. The method includes providing information indicating an operation relates to an external workload of a plurality of external workloads supported by the processor; and processing the operation in accordance with the information.

Other aspects provide: an apparatus operable, configured, or otherwise adapted to perform any one or more of the aforementioned methods and/or those described elsewhere herein; a non-transitory, computer-readable media comprising instructions that, when executed (e.g., directly, indirectly, after pre-processing, without pre-processing) by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example computing environment with a memory management unit (MMU) and translation lookaside buffer (TLB) according to various aspects of the present disclosure.

FIG. 2 illustrates example of a system memory management unit (SMMU) and TLB according to various aspects of the present disclosure.

FIG. 3 illustrates a system for managing partitioning and allocation of memory regions associated with one or more processors according to various aspects of the present disclosure.

FIG. 4 illustrates an example enhancement mapping of virtual address (VA) to physical address (PA) and memory regions according to various aspects of the present disclosure.

FIGS. 5A and 5B illustrate example operations for supporting multiple external workloads according to various aspects of the present disclosure.

FIG. 6 illustrates an example method according to various aspects of the present disclosure.

FIG. 7 illustrates an example method according to various aspects of the present disclosure.

FIG. 8 depicts aspects of an example device according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

A memory management unit (MMU) generally refers to a hardware component in a processor responsible for performing address translation from virtual addresses to physical addresses. The MMU plays a critical role in computing systems by enabling efficient memory usage, process isolation, and device and memory protection. The MMU ensures that a process cannot access address ranges allocated exclusively to other processes or the operating system. The MMU facilitates memory sharing between processes while ensuring isolation to prevent unintended disclosure or interference. In a processor that supports virtualization, the MMU ensures that a process or operating system in one VM cannot access address ranges allocated exclusively allocated to other VMs or the hypervisor. The MMU may include a translation lookaside buffer (TLB), page tables, and/or access control logic. The TLB is a specialized cache within the MMU that stores recent address translations. The page tables are data structures maintained by an operating system and a hypervisor that map the virtual addresses to the physical addresses. The MMU consults these tables during address translation. The access control logic verifies access permissions (e.g., whether a process can read, write, or execute a specific address range).

A system MMU (SMMU), also known as an input/output MMU (IOMMU), generally refers a specialized hardware component used in system on chips (SoCs) and computing platforms. The SMMU is designed to manage access and translation specifically for devices like network adapters, and other hardware accelerators that need to access physical address ranges. The SMMU serves a role similar to the MMU, but it operates for peripheral devices instead of the processor. The SMMU enforces access control for devices, ensuring they read or write only to allowed address ranges. The SMMU allows virtual machines to use devices without direct intervention from a hypervisor by providing address translation and isolation for those devices. Multiple devices and virtual machines may share a single SMMU, which selects the corresponding page tables based on identifiers that accompany each incoming transaction, such as a StreamID (SID), that indicate a set of transactions called a transaction stream, with common access policies and translation regimes

In the context of secure processing, a world, also known as a supervisor domain or secure arbitration mode, may refer to a separate security state providing an isolated execution environment within a processor. A world may be designed to protect processing of sensitive data with sensitive code by preventing unintended access or interference from existing processes, operating systems, virtual machines and the hypervisor, which may be known collectively as the “normal” world. Different processor architectures may support one or more worlds; at least two worlds are required to provide confidential computing capabilities. Like the normal world, other worlds may themselves be partitioned into isolated execution environments hosting virtual machines and possibly a hypervisor. In some processor architectures, all worlds are equivalent and there is no distinguished “normal” world.

In the context of secure processing, the physical address space (PAS) may be partitioned between processor worlds. An MMU or SMMU may support worlds by providing isolation mechanisms designed to ensure that processes and devices are allowed to access only the physical address (PA) ranges assigned to them. The PA ranges assigned to a world may be referred to as the world PAS. The MMU or SMMU may also facilitate memory sharing between worlds while ensuring isolation to prevent unintended disclosure or interference. In some cases, this isolation may be accomplished by performing a check of physical addresses, after virtual address (VA) to physical address (PA) translation, to ensure a process or device in a given world is allowed to access a given PA range. If the check fails, meaning a particular PA range is not allowed for a given world PAS, a process or device seeking access may be denied and a fault may be created.

An SMMU may help support worlds by providing isolation mechanisms designed to ensure that ensures devices are allowed to access only the memory areas assigned to them. These memory areas or regions may be referred to as physical address spaces (PASs) and may have a corresponding security state (which may correspond to a security state of a world). In some cases, this isolation be accomplished by performing a check of physical addresses, after virtual address (VA) to physical address (PA) translation, to ensure a device is allowed to access a given memory region or PAS. If the check fails, meaning a particular PAS is not allowed for a given PA, a device seeking access may be denied and a fault may be created.

Aspects of the present disclosure provide various mechanisms that may help enhance the support of additional worlds (called SoC worlds) and related workloads associated with devices and execution environments supplemental to the available processor security states. The signaling mechanisms may help support a quantity (e.g., an extensible quantity) of off application processor (off-AP) distrusted workloads.

### Example System-on-a-chip (SoC)

System-on-a-chip (SoC) devices may include one or more central or application processors, one or more interconnects (or buses), one or more peripheral devices (or upstream devices), and one or more slave devices. The SoC devices may further include a memory management unit (MMU) coupled to a processor and one or more system MMUs (SMMUs) coupled to the one or more peripheral devices.

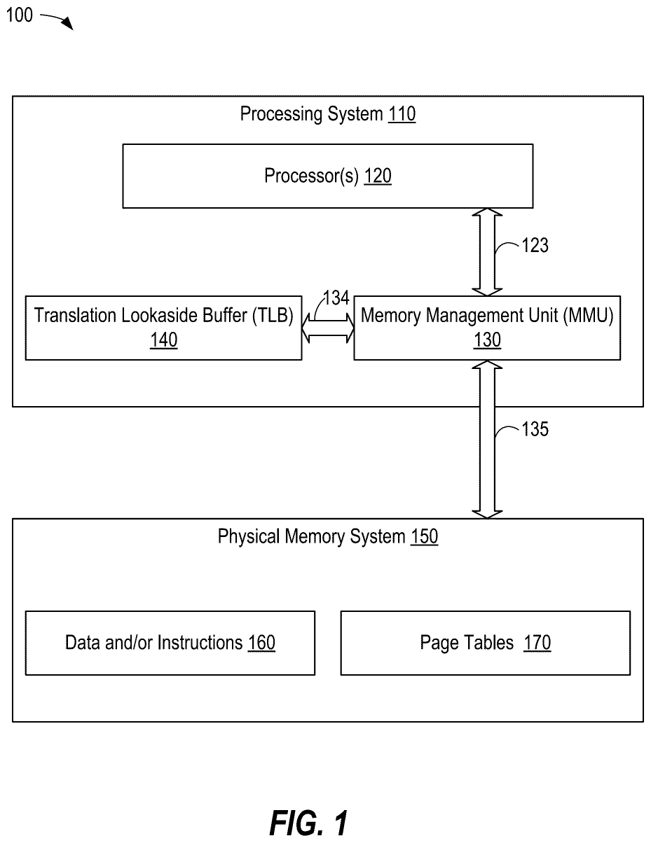

FIG. 1 illustrates an example computing environment 100 according to various aspects of the present disclosure. The computing environment 100 includes a processing system 110, which represents a physical computing device or a virtual computing device that runs a on a physical computing device. Processing system 110 includes one or more processors 120, which may represent central processing units (CPUs) and/or other processing devices configured to execute instructions to perform various computing operations. As used herein, the terms processor and CPU may be used interchangeably and may refer to a same entity.

A processor interconnect 123 may couple the processor(s) 120 to a MMU 130 of the processing system 110. The MMU 130 may perform translation of virtual memory addresses into physical memory addresses. The MMU 130 may be coupled to a TLB 140 of the processing system 110 via a TLB path 134. The TLB 140 may include mappings of virtual memory addresses to physical memory addresses that have been cached.

The computing environment 100 further includes a physical memory system 150, which may include data and/or instructions 160 and page tables 170. The physical memory system 150 may be, for example a random access memory (RAM). The MMU 130 may be coupled to the physical memory system 150 via a physical memory interconnect 135.

The page tables 170 map each virtual address used by the processing system 110 to a corresponding physical address associated with the physical memory system 150. The physical address may be located in the physical memory system 150, a hard drive (not shown), or some other storage component. When the processing system 110 needs to access (e.g., read or write) data, the processor(s) 120 may send the virtual address of the requested data to the MMU 130. The MMU 130 may perform the translation in tandem with the TLB 140 and/or physical memory system 150 and then return the corresponding physical address to the processor(s) 120.

To perform the translation, the MMU 130 first checks the TLB 140 to determine if the virtual address of the requested data matches a virtual address associated with one of the TLB 140 entries. If there is a match between the requested virtual address and a virtual address in a particular TLB 140 entry, the processing system checks the TLB 140 entry to determine whether the valid bit is set. If the entry is valid, then the TLB 140 entry includes a valid translation of the virtual address. Accordingly, a corresponding physical address can be returned very quickly to the MMU 130, thereby completing the translation. Using the translated physical address, the processing system 110 can access the requested data.

If the MMU 130 determines that the virtual address of the requested data does not match a virtual address associated with one of the TLB 140 entries (or if a matching TLB 140 entry is marked as invalid), then the MMU 130 walks through the page tables 170 in the physical memory system 150 until a matching virtual address is found.

Each translation may be performed in levels. For example, the MMU 130 may walk through a first page table of the page tables 170 in search of a match. A matching entry found in the first page table may include the first several bits of a physical address and an indication that additional bits may be found in a second page table of the page tables 170. The MMU 130 may then store the first several bits and walk through the second page table in search of a match. As noted above, the matching entry may include the next several bits of the physical address, and the process repeats if the matching entry includes an indication that additional bits may be found in a third page table of the page tables 170. The process may repeat until the matching entry indicates that a last level of translation has been reached. The last level may be, for example, the level that was most-recently reached. Once the last level of translation has been completed, the MMU 130 should have a complete translation of the full physical address.

If there is a match between the requested virtual address and a virtual address in a particular page table entry, the processing system 110 retrieves a physical address from the page table entry. Once found, the physical address is returned to the MMU 130. However, using the page tables 170 to perform the translation may be much slower than using the TLB 140. The TLB 140 is smaller than the physical memory system 150 and less remote than the physical memory system 150. Accordingly, the TLB 140 may be searched more quickly. The TLB 140 typically replicates a subset of the translations located in the page tables 170. The replicated translations are generally associated with virtual addresses that are most important, most frequently-used, and/or most recently-used.

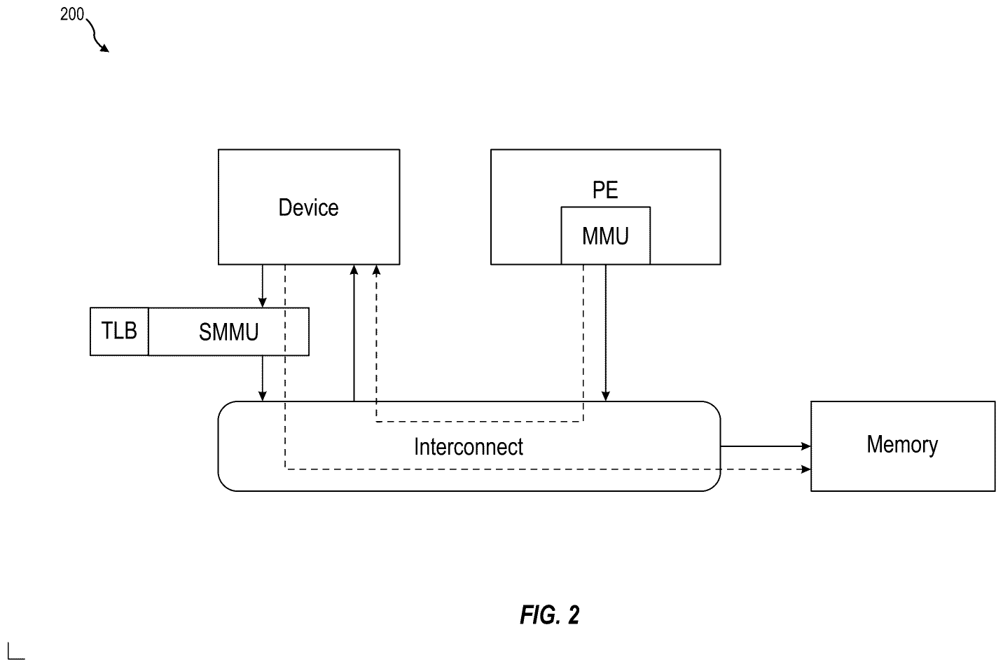

FIG. 2 is an illustration 200 of an example of a SMMU according to various aspects of the present disclosure. The SMMU performs a task that may be considered analogous to that of a MMU (e.g., the MMU 130 of FIG. 1) in a processing element (PE). For example, the SMMU may translate addresses for direct memory access (DMA) requests from a system input/output (I/O) device before the DMA requests are passed into a system interconnect. The SMMU may be active for DMA only. The translation of the DMA addresses may be performed for reasons of isolation or convenience.

The SMMU may only provide translation services for transactions from the device, and not for transactions to the device. For example, traffic (or transactions) in the other direction, that is, from a processing system to the device may be managed by other means such as a processing system MMU.

In some aspects, in order to associate device traffic with translations and to differentiate different devices behind the SMMU, the DMA requests may have extra information, alongside address and access type (read/write). For example, this extra information may include a StreamID (SID). As described above, an SID may indicates a set of transactions called a transaction stream, with common access policies and translation regimes. Different streams may be logically associated with different devices, device states or data types and the SMMU may perform different translations or checks for each stream.

In some aspects, a number of SMMUs may exist within a system. Each SMMU may translate traffic from one device or a set of devices.

The SMMU may support two stages of translation in a similar way to PEs supporting virtualization extensions. Each stage of translation may be independently enabled. An incoming address may be logically translated from a virtual address (VA) to an intermediate physical address (IPA) in stage 1, then the IPA is input to stage 2 which translates the IPA to an output physical address (PA). Stage 1 is intended to be used by a software entity to provide isolation or translation to buffers within an entity. Stage 2 is intended to be available in systems supporting the virtualization extensions and is intended to virtualize device DMA to guest virtual machine (VM) address spaces. When both stage 1 and stage 2 are enabled, the translation configuration is called nested.

The SMMU may have three interfaces that software uses. For example, the SMMU may include memory-based data structures that may be used to map devices to translation tables that are used to translate device addresses. The SMMU may include memory-based circular buffer queues such as a command queue for commands to the SMMU and an event queue for event/fault reports from the SMMU. The SMMU may include a set of registers, some of which are secure-only, for discovery and SMMU-global configuration. The registers indicate base addresses of the structures and queues, provide feature detection and identification registers and a global control register to enable queue processing and translation of traffic.

In some aspects, an incoming transaction may have an address, size, and attributes such as read/write, secure/non-secure, share ability, and cache ability. If more than one device or a device shared by more than one VM or more than one World uses the SMMU, the traffic may also have a World ID and a Stream ID so the sources can be differentiated. Incoming transactions with the same World ID and Stream ID are initiated by the same device and share the same access and translation regimes. The Stream ID corresponds to the device that initiated a transaction.

The SMMU may use a set of data structures in a memory to locate translation data. The registers may hold base addresses of an initial root structure, for example, in a stream table. A stream table entry (STE) may include stage 2 translation table base pointers, and also locates stage 1 configuration structures, which contain translation table base pointers. A context descriptor (CD) represents stage 1 translation, and the STE represents stage 2 translation. In some aspects, there are three address size models to consider in the SMMU such as an input address size from a system, an intermediate address size (IAS), and an output address size (OAS). The SMMU input address size is 64 bits. The IAS reflects a maximum usable IPA of an implementation that is generated by stage 1 and input to stage 2. The OAS reflects a maximum usable PA output from a last stage of translations, and must match a system physical address size.

### Example Partitioning and Allocation of Memory Associated with a Processor

Aspects of the present disclosure provide apparatuses, methods, processing systems, and computer-readable mediums for managing partitioning and allocation of memory regions (e.g., address spaces) associated with one or more processors for different tasks.

One or more mechanisms may be used for partitioning operations of a processor (e.g., a central processing unit) into mutually distrusting domains (e.g., processing domains or worlds). The mutually distrusting domains associated with the processor may refer to separate execution environments or contexts within the processor (or a system) that are isolated from each other due to security, privacy, and/or integrity concerns. The mutually distrusting domains associated with the processor do not trust each other, meaning that they operate under the assumption that other domains may attempt to compromise their security or integrity. The operations of the processor may be partitioned into the mutually distrusting domains to protect confidentiality of resources in the different domains associated with the processor.

The different mechanisms for partitioning the operations of the processor into the mutually distrusting domains may include a confidential virtual machine environment (CoVE) mechanism, a confidential compute architecture (CCA) mechanism, a trust domain extension (TDX) mechanism, etc. Such mechanisms may be designed with a focus on confidentiality and security of data, and to provide strong isolation for workloads running in virtual machines. Such mechanisms may help establish trusted execution environments or trust domains within a system.

In some distributed computing systems, software or hardware creates an abstraction of a shared memory space across physically separate processors. This allows processors to lend parts of their memory space to others indirectly by making it accessible across the network.

In some systems, a processor may be able to donate resources (e.g., in a physical address space) under its control to an off-processor entity (e.g., another processor) such that operations of the off-processor entity may be kept confidential from a donor processor (i.e., the processor which donates the resources under its control to the off-processor entity). The physical address space refers to an actual range of addresses that a computer's physical memory can access. It represents the hardware's view of memory locations and is determined by the system's memory architecture and the number of address lines on the processor.

In some systems, one or more confidential processing domains or worlds under the processor control may coexist with more than one confidential processing domain or world controlled by more than one off-processor entity.

In some systems, a stage 3 checker (e.g., based on walking page tables) may be used to verify that stage 1 and 2 memory translations from a memory management unit (MMU)/system memory management unit (SMMU) in different processing domains or worlds associated with the processor (e.g., which may be under control of untrusted hypervisors) are valid. The stage 1 translation may translate virtual addresses used by a software (e.g., a process or virtual machine) into intermediate physical addresses. The stage 2 translation may translate the intermediate physical addresses (from stage 1) into the actual physical addresses used by a hardware. In memory system designs, a stage 3 checker may be a final stage in a series of validation steps (e.g., checking translation correctness after stage 1 and stage 2 translations in a virtualized system).

In some systems, a trusted off-processor entity (e.g., such as a system on a chip (SoC) world controller) that may control programming of stage 3 tables (e.g., preventing interference with the stage 3 tables by the processor) may assist. For example, if the trusted off-processor entity may be provided with multiple interfaces, the trusted off-processor entity may operate a memory partitioning protocol allowing co-operation between multiple distrusting domains or actors associated with the trusted off-processor entity.

In some systems, it may be costly in terms of a memory to have all mutually untrusting domains in a system mapped into worlds as this may make required tables unreasonably large, and it might then be desirable to use the stage 3 checker in conjunction with slave-side memory protection units which sub-partition a physical memory allocated to some or all domains. In some cases, placing the memory protection units under control of the SoC world controller may allow for enhanced memory management protocols.

Techniques described herein define a trusted off-processor entity that may manage or control domains separation for a processor. The trusted off-processor entity may act as a relay to manage or control physical address (or memory) partitioning provided by xPUs. An xPU may refer to a memory protection unit (MPU, where x=M), register protection unit (RPU, where x=R) or address protection unit (APU, where x=A). The techniques described herein may allow to sub-partition off processor resources (e.g., such as memory resources) provided by the processor at a lower cost than instantiating additional SMMU components.

One or more hardware devices used to implement the techniques described herein may be managed using a memory management protocol, which may be enhanced with knowledge of SoC sub-domains. One approach may be to enhance or extend a memory protocol to the hardware devices to be SoC sub-domain aware.

The sub-partitioning of processor managed domains or worlds may be performed a low hardware cost. Also, the hardware devices may be easy to integrate with existing systems. These improvements are particularly advantageous in contexts where computing resources are limited and/or where memory management performance is key, such as in the context of mobile devices, machine learning, and/or the like.

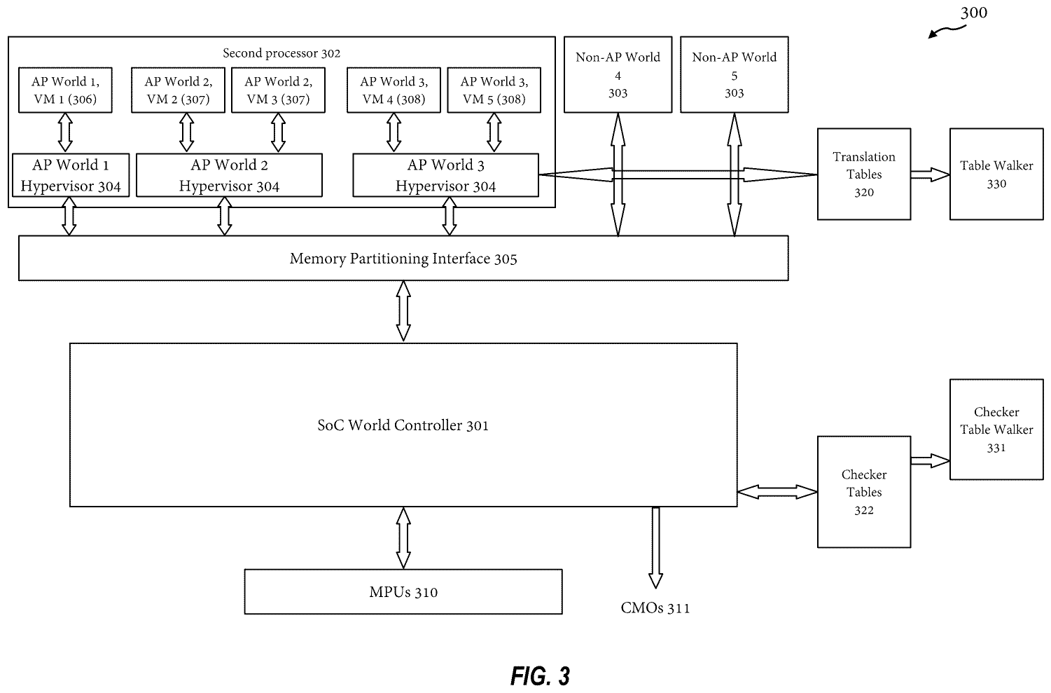

FIG. 3 illustrates a system 300 for managing partitioning and allocation of memory regions associated with one or more processors. The system 300 may include a SoC world controller 301 (e.g., which may be or is associated with a first processor), multiple endpoints (e.g., devices) associated with a second processor 302 (e.g., such as a main processor), and memory protection units (MPUs) 310. The SoC world controller 301 may be associated with the MPUs 310. The SoC world controller 301 may be capable of issuing cache management operations (CMOs) 311 to any of the second, third or subsequent processors. The SoC world controller 301 may be associated with the multiple endpoints 306, 307, 308 and multiple hypervisors 304 associated with the second processor 302 or endpoints associated with third and subsequent processors 303.

The SoC world controller 301 may further be associated with translation tables 320, protection checker tables 322, a translation table walker 330 and/or a checker table walker 331.

The checker tables 322 provide mechanisms for partitioning the address space of the system 300 into multiple regions that are accessible to one or more worlds. The checker tables 322 holds data structures in a memory that are used to manage and enforce memory protection at the granularity of memory granules (e.g., fixed-size blocks of the memory), allowing fine-grained control over memory access. The checker table walker 331 is a hardware or software mechanism responsible for traversing the data structures in the checker tables 322 to resolve access permissions and attributes for memory regions. It is part of a MMU in systems that use the checker tables 322 to enforce physical memory access control.

The translation table walker 330 may be a component of an MMU-based memory management system in modern processors. The translation table walker 330 traverses the translation tables 320 to resolve memory addresses and enforce access permissions for virtual memory and virtualization systems. The translation tables 320 may be configured by a hypervisor 304. As already described for the translation tables 320, the checker tables 322 may also be hierarchical data structures decomposed into two or more levels for efficiency of storage and traversal.

The SoC world controller 301 may be associated with and implement a memory partitioning interface (or a memory partitioning mechanism) 305. The memory partitioning mechanism 305 of the SoC world controller 301 may perform partitioning of a physical address space or a memory associated with the second processor 302 to create mutually untrusting memory regions. The mutually untrusting memory regions on the second processor 302 may be called worlds 306, 307, 308 (e.g., which may be enforced by MMU/SMMU checking tables (e.g., granule protection tables, memory tracking table for supervisor domain isolation)). An MMU/SMMU may support separate translation tables and hypervisors for each world.

The SoC world controller 301 may receive partitioning information for partitioning the memory associated with the second processor 302 into the mutually untrusting memory regions from one or more mechanisms, that may partition the memory associated with the second processor 302 based on a physical address, such as the MPUs 310. The MPU 310 may be a hardware component in a processor designed to enforce access restrictions to different regions of the memory. The MPU 310 may ensure that only authorized processes or programs can access specific areas of memory, enhancing security, stability, and reliability in embedded and real-time systems.

The SoC world controller 301 may receive partitioning information for partitioning the memory associated with the second processor 302 into the mutually untrusting memory regions from one or more mechanisms, that may partition the memory associated with the second processor 302 based on both translation and physical address, such as the MMU.

The SoC world controller 301 may allocate partitioned memory regions associated with the second processor 302 to different endpoints 306, 307, 308 or other processors. For example, an endpoint may be allocated one or more memory regions or worlds associated with the a third or subsequent processor.

In certain aspects, the SoC world controller 301 may perform permanent transfer operations corresponding to the partitioned memory regions associated with the second processor 302. For instance, the memory partitioning mechanism 305 may transfer ownership of a memory region associated with the second processor 302 from one virtual machine endpoint to another virtual machine endpoint within the same world.

In one example, the memory partitioning mechanism 305 may transfer the ownership of the one or more memory regions associated with the second processor 302 allocated for a first processing domain (e.g., application processor (AP) world 2, virtual machine (VM) 2 (307)) associated with the second processor 302 to a second processing domain (e.g., AP world 1, VM 1 (306)) associated with the second processor.

In another example, the memory partitioning mechanism 305 may transfer the ownership of the one or more memory regions associated with the second processor 302 allocated for a donator endpoint (e.g., AP world 2, VM 3 (307)) to a receiver endpoint (e.g., a non-AP world 4 or 5 (303)).

In certain aspects, the SoC world controller 301 may perform lending operations corresponding to the partitioned memory regions associated with the second processor 302. For instance, the memory partitioning mechanism 305 may transfer access rights to a memory region to one or more borrower endpoints without relinquishing ownership but explicitly relinquishing access rights.

In one example, the memory partitioning mechanism 305 may transfer access rights of the one or more memory regions associated with the second processor 302 allocated for the first processing domain associated with the second processor 302 to the second processing domain associated with the second processor 302.

In another example, the memory partitioning mechanism 305 may transfer access rights of the one or more memory regions associated with the second processor 302 allocated for a lender endpoint to a borrower endpoint.

In certain aspects, the SoC world controller 301 may perform share operations corresponding to the partitioned memory regions associated with the second processor 302, to enable access by more than one endpoint. For instance, the memory partitioning mechanism 305 may transfer access rights to a memory region to one or more borrower endpoints while retaining ownership and access rights.

In one example, the memory partitioning mechanism 305 may temporarily share access rights of the one or more memory regions associated with the second processor 302 allocated for the first processing domain associated with the second processor 302 with the second processing domain associated with the second processor 302 for a threshold period.

In another example, the memory partitioning mechanism 305 may temporarily share access rights of the one or more memory regions associated with the second processor 302 allocated for a lender endpoint with a receiver endpoint on a third or subsequent processor for a threshold period.

In certain aspects, the SoC world controller 301 may perform reclaim operations corresponding to the partitioned memory regions associated with the second processor 302. For instance, an owner of a memory region may request that one or more borrower endpoints may relinquish their access rights to a memory region so that the owner can reclaim access.

In one example, the owner of the memory region may request the second processing domain associated with the second processor 302 to relinquish the access rights of the memory region. The owner of the memory region may receive a notification from the second processing domain associated with the second processor 302 that the second processing domain has relinquished the access rights of the memory region.

In another example, the owner of the memory region may request the borrower endpoint on the third or subsequent processor to relinquish the access rights of the memory region. The owner of the memory region may receive a notification from the borrower endpoint that the borrower endpoint has relinquished the access rights of the memory region.

### Example Mapping of VAs and PAs to PA Spaces

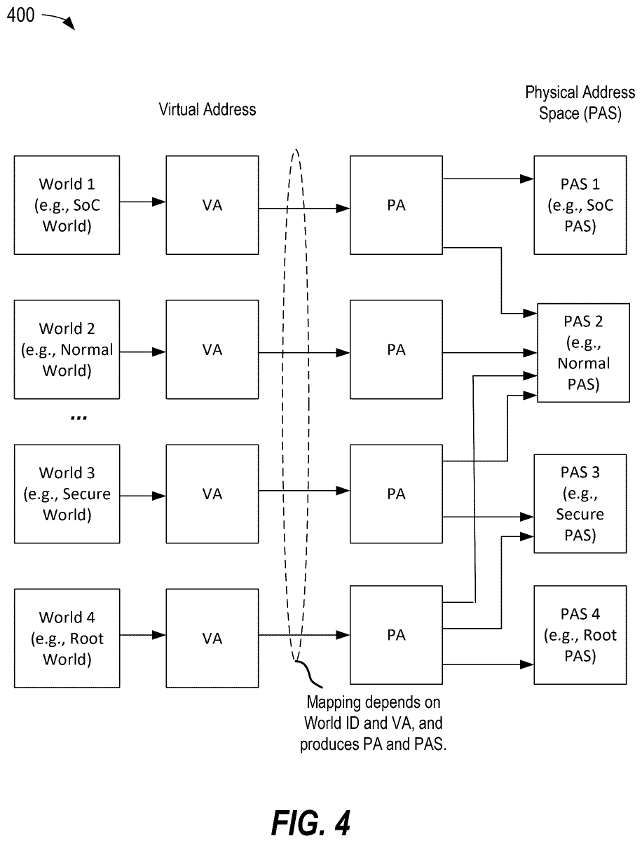

Diagram 400 of FIG. 4 illustrates an example mapping of VAs and PAs to physical address spaces (PASs) associated with different worlds (or security states). For illustrative purposes, four security states (Security States 1-4) are shown in the example illustrated in FIG. 4.

As illustrated, there may be multiple PASs, corresponding to different worlds. In the illustrated example, these PASs include a Secure PAS, a non-secure PAS, a Realm PAS, and a Root PAS.

As illustrated, which PA space (or spaces), a virtual address can be mapped to depends on the current Security state of a corresponding processing element (PE) or device. For example, for a Non-secure state, virtual addresses may only map to Non-secure physical addresses.

For a secure state, virtual addresses may map to Secure or Non-secure physical addresses. For a realm state, virtual addresses may map to Realm or Non-secure physical addresses (and PASs). For a root state, virtual addresses may map to any physical address space. When a PE is in a Security state that can access multiple PASs, translation table entries may control which PAS is used.

As indicated in FIG. 4, the particular mapping of any given VA to a PAS may depend on security attribute bits. Such bits may include, for example, bits referred to as non-secure (NS) bits used to indicate whether a translated physical address targets secure(S) or non-secure (NS) memory and/or NS extension (NSE) bits.

Certain aspects of the present disclosure may utilize a plurality of such bits to indicate a relatively large quantity of external workloads (e.g., associated with off-AP Worlds).

### Example Support for Multiple Distrusting External Workloads

As noted above, one or more confidential processing domains or worlds under the processor control may coexist with more than one confidential processing domain or world controlled by more than one off-processor entity. In certain scenarios, multiple such off-processor entities may have external workloads that share resources in a secure computing environment. Aspects of the present disclosure may help support distrusted workloads associated with one or more off application (off-AP) processors.

As noted above, a world or realm may refer to a separate, isolated execution environment within a processor architecture. A world or realm may be designed to protect sensitive data and code by preventing access from other parts of the system, like the operating system, helping to ensure confidential computing capabilities. A world may be considered a secure space where applications may run without exposing their data to the wider system.

Aspects of the present disclosure provide various signaling mechanisms that may help enhance the support of worlds (and related workloads) associated with different security states. The signaling mechanisms may help support a quantity (e.g., an extensible quantity) of off application processor (off-AP) distrusted workloads.

Mechanisms proposed herein may help enhance the number of worlds supported and provide flexibility for modifying allowed permissions for the different worlds. In particular, signaling mechanisms proposed herein may provide information about a potentially large quantity of external workloads.

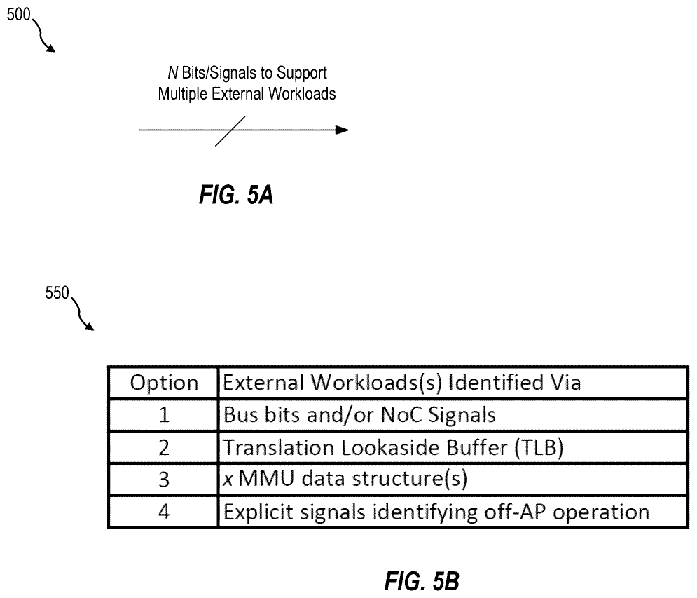

As illustrated in diagram 500 of FIG. 5A, in some cases information regarding a relatively large quantity of off-AP worlds may be carried over a bus or via network on a chip (NoC) signals.

For example, an NS bit may be used to indicate the use of trust zone and convey information about off SoC worlds. As an example, given N bits, up to 2^{N} different off SoC worlds may be indicated.

As illustrated in table 550 of FIG. 5B, as an alternative (or in addition) to carrying additional signals on the buses, information regarding off-AP worlds may be provided in a translation lookaside buffer (TLB) to help support off-AP worlds.

Such information may also be provided via various data structures used by one or more types of memory management units (MMUs). In some cases, such information may be provided via additional explicit signals and/or via certain registers that may be defined for off AP operations.

According to certain aspects, the signaling mechanisms may provide information about external workloads as bus and/or network on a chip in a translation lookaside buffer (TLB). In some cases, the signaling may be provided via page tables and other data structures or in inferable from them.

Information regarding multiple external workloads may be provided in a transaction that also contains various other information. For example, in addition to multiple external worlds, such information may also include a stream ID, a virtual address (VA or Vas), and whether or not the transaction is a read or a write transaction.

Certain worlds may be considered CPU worlds while other worlds are considered SoC worlds. CPU worlds may include non secure (NS), secure realm, and rout worlds. Other worlds may be considered SoC worlds, which may include any number of implementation defined SoC worlds. Mechanisms proposed herein may help support a number of such additional worlds. In some cases, such worlds may be identified via one or more bits. In some cases, such bits may be provided via one or more a protected mode (PM) signals.

In some cases, one or more page tables may be selected using the stream ID. The VA may be translated to a PA, using a page table. As illustrated, a page table may include an additional output, which may be a PA space (mapped to the PA).

In some cases, a check may be performed of allowed PAS using the PA and one or more protection tables. For example, the PA may be used to look up protection information from a table, which may be referred to as a protection table or a granular protection table (GPT so called as it applies to a granular amount of memory).

A check performed may involve comparing the PAS obtained from a table to the PAS from another table. This check may indicate whether the PAS obtained from the other table is allowed for the PA. If the check fails, an exception (or fault) may be declared, and the desired memory access via the transaction may be denied.

In this manner, protection tables may be updated and used to control access for various worlds. This updating of a protection table (e.g., GPT) may be performed, for example, by an SoC World controller (described above with reference to FIG. 3). In some cases, a GPT may be held in Root memory to ensure that it is isolated from all other worlds (and may only be created and modified by code running in the Root world, from the Monitor code or Trusted Firmware).

In general, the protection check which checks for which physical address spaces (PASs) are allowed or a particular physical address. In some cases, a simple table may be used to obtain a physical address that is allowed, a physical address space that is allowed (for that PA), or there may be a value indicating no PASs are allowed.

According to certain aspects, signaling mechanisms proposed herein may be used in conjunction with a GPT, to support multiple external worlds. According to certain aspects, a different encoding of GPT tables may be used when supporting a relatively large number of worlds.

In some cases, it might be necessary to allow an off-AP to initiate certain on-AP operations. For example, if resources are reconfigured such that the resources that were previously accessible to one world are no longer accessible, cash flushes may be triggered.

Flushing cashes on a processor, whether they are the AP or an off AP, flushing the caches may help to ensure that previously cached information that is in a region of memory that has now been reconfigured, the allocated region is no longer in cache. As an example, if a piece of memory that belongs to the application processor is reconfigured and allocated to a different process of a world owned by a different processor, the cache may be flushed on the application (or other) processor, because if any of the addresses for that region had been cached, these addresses may no longer be valid.

### Example Methods

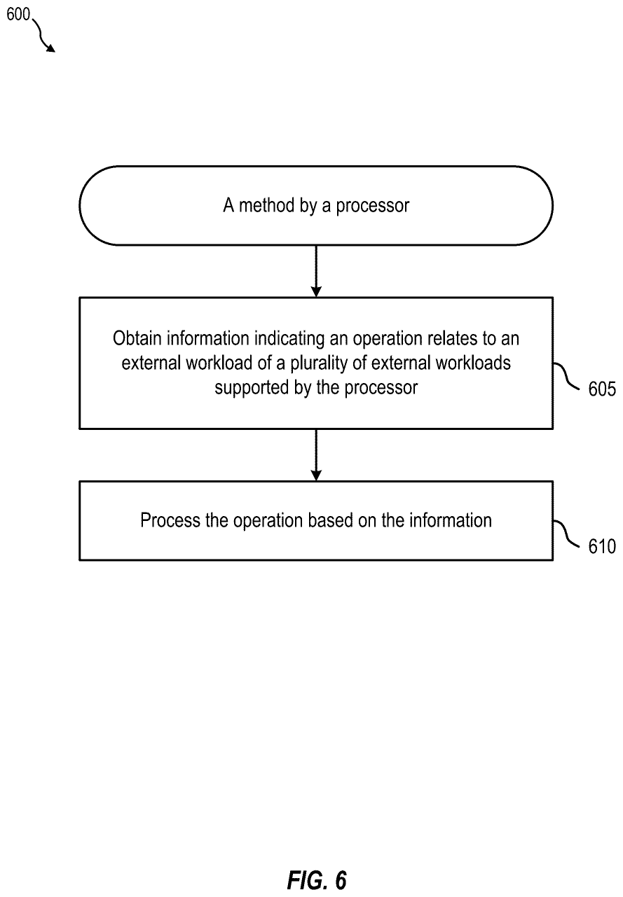

FIG. 6 shows an example of a method 600.

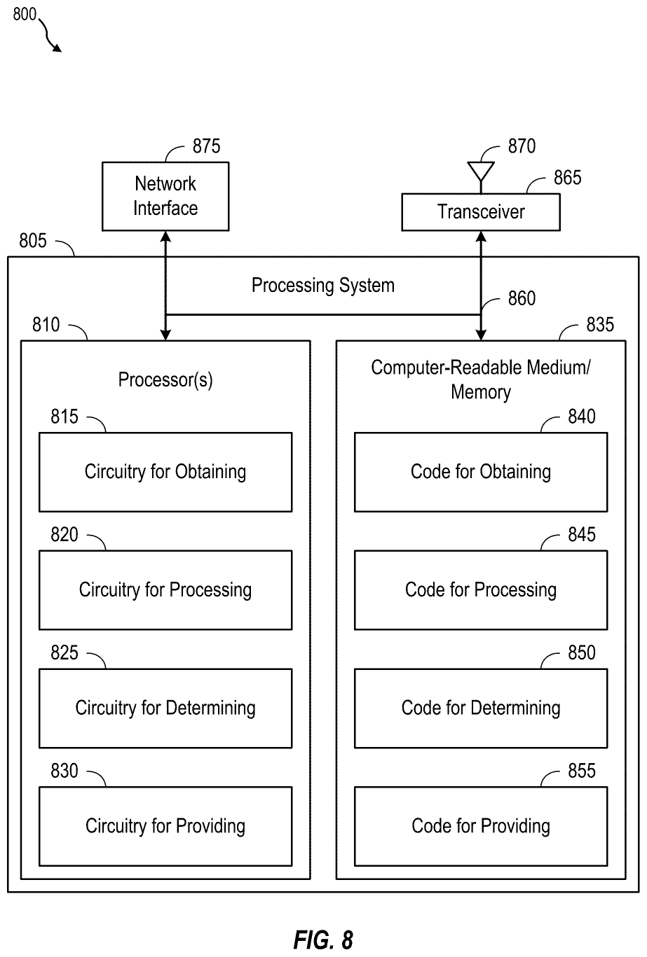

Method 600 begins at step 605 with obtaining information indicating an operation relates to an external workload of a plurality of external workloads supported by the processor. In some cases, the operations of this step refer to, or may be performed by, circuitry for obtaining and/or code for obtaining as described with reference to FIG. 8.

Method 600 then proceeds to step 610 with processing the operation based on the information. In some cases, the operations of this step refer to, or may be performed by, circuitry for processing and/or code for processing as described with reference to FIG. 8.

In some aspects, the processor is associated with a first security state; and the external workload involves access to memory associated with a second security state.

In some aspects, the information is obtained via a plurality of physical address space (PAS) signals.

In some aspects, the information is obtained via a plurality of bits on a bus or network on a chip (NoC).

In some aspects, the information is obtained via a translation lookaside buffer (TLB).

In some aspects, the information is obtained via a data structure associated with at least one memory management unit (MMU).

In some aspects, the processing comprises initiating a cache flush if the information indicates a change in contents of a memory partitioning table.

In some aspects, the operation involves a virtual address (VA) that maps to a physical address (PA); and the information is obtained via a table used to determine whether one or more physical address spaces (PASs) are allowed for the PA.

In some aspects, information in the table is encoded to support the plurality of external workloads.

In some aspects, the method 600 further includes determining a quantity of external workloads supported. In some cases, the operations of this step refer to, or may be performed by, circuitry for determining and/or code for determining as described with reference to FIG. 8.

In some aspects, the quantity of external workloads supported is adjustable.

In one aspect, method 600, or any aspect related to it, may be performed by an apparatus, such as device 800 of FIG. 8, which includes various components operable, configured, or adapted to perform the method 600. Device 800 is described below in further detail.

Note that FIG. 6 is just one example of a method, and other methods including fewer, additional, or alternative steps are possible consistent with this disclosure.

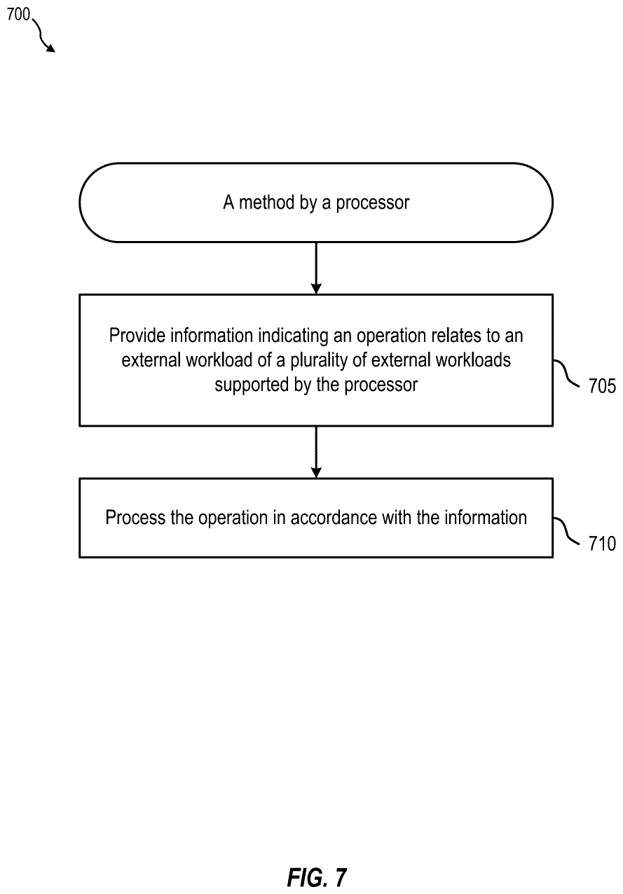

FIG. 7 shows an example of a method 700.

Method 700 begins at step 705 with providing information indicating an operation relates to an external workload of a plurality of external workloads supported by the processor. In some cases, the operations of this step refer to, or may be performed by, circuitry for providing and/or code for providing as described with reference to FIG. 8.

Method 700 then proceeds to step 710 with processing the operation in accordance with the information. In some cases, the operations of this step refer to, or may be performed by, circuitry for processing and/or code for processing as described with reference to FIG. 8.

In some aspects, the information is provided to another processor associated with a first security state; and the external workload involves access to memory associated with a second security state.

In some aspects, the information is provided via a plurality of physical address space (PAS) signals.

In some aspects, the information is provided via a plurality of bits on a bus or network on a chip (NoC).

In some aspects, the information is provided via a translation lookaside buffer (TLB).

In some aspects, the information is provided via a data structure associated with at least one memory management unit (MMU).

In some aspects, the operation involves a virtual address (VA) that maps to a physical address (PA); and the information is obtained via a table used to determine whether one or more physical address spaces (PASs) are allowed for the PA.

In some aspects, information in the table is encoded to support the plurality of external workloads.

In one aspect, method 700, or any aspect related to it, may be performed by an apparatus, such as device 800 of FIG. 8, which includes various components operable, configured, or adapted to perform the method 700. Device 800 is described below in further detail.

Note that FIG. 7 is just one example of a method, and other methods including fewer, additional, or alternative steps are possible consistent with this disclosure.

### Example Device

FIG. 8 depicts aspects of an example device 800.

The device 800 includes a processing system 805 coupled to the transceiver 865 (e.g., a transmitter and/or a receiver) and/or a network interface 875. The transceiver 865 is configured to transmit and receive signals for the device 800 via the antenna 870, such as the various signals as described herein. The network interface 875 is configured to obtain and send signals for the device 800 via communication link(s), such as a backhaul link, midhaul link, and/or fronthaul link. The processing system 805 may be configured to perform processing functions for the device 800, including processing signals received and/or to be transmitted by the device 800.

The processing system 805 includes one or more processors 810. The one or more processors 810 are coupled to a computer-readable medium/memory 835 via a bus 860. In certain aspects, the computer-readable medium/memory 835 is configured to store instructions (e.g., computer-executable code) that when executed by the one or more processors 810, cause the one or more processors 810 to perform the method 600 described with respect to FIG. 6, or any aspect related to it; and the method 700 described with respect to FIG. 7, or any aspect related to it. Note that reference to a processor of device 800 performing a function may include one or more processors 810 of device 800 performing that function.

In the depicted example, the computer-readable medium/memory 835 stores code (e.g., executable instructions), such as code for obtaining 840, code for processing 845, code for determining 850, and code for providing 855. Processing of the code for obtaining 840, code for processing 845, code for determining 850, and code for providing 855 may cause the device 800 to perform the method 600 described with respect to FIG. 6, or any aspect related to it; and the method 700 described with respect to FIG. 7, or any aspect related to it.

The one or more processors 810 include circuitry configured to implement (e.g., execute) the code stored in the computer-readable medium/memory 835, including circuitry such as circuitry for obtaining 815, circuitry for processing 820, circuitry for determining 825, and circuitry for providing 830. Processing with circuitry for obtaining 815, circuitry for processing 820, circuitry for determining 825, and circuitry for providing 830 may cause the device 800 to perform the method 600 described with respect to FIG. 6, or any aspect related to it; and the method 700 described with respect to FIG. 7, or any aspect related to it.

Various components of the device 800 may provide means for performing the method 600 described with respect to FIG. 6, or any aspect related to it; and the method 700 described with respect to FIG. 7, or any aspect related to it. Means for transmitting, sending or outputting for transmission may include the transceiver 865 and the antenna 870 of the device 800 in FIG. 8. Means for receiving or obtaining may include the transceiver 865 and the antenna 870 of the device 800 in FIG. 8.

### Example Clauses

Implementation examples are described in the following numbered clauses:

Clause 1: A method by a processor, comprising: obtaining information indicating an operation relates to an external workload of a plurality of external workloads supported by the processor; and processing the operation based on the information.

Clause 2: The method of Clause 1, wherein: the processor is associated with a first security state; and the external workload involves access to memory associated with a second security state.

Clause 3: The method of any one of Clauses 1-2, wherein the information is obtained via a plurality of physical address space (PAS) signals.

Clause 4: The method of any one of Clauses 1-3, wherein the information is obtained via a plurality of bits on a bus or network on a chip (NoC).

Clause 5: The method of any one of Clauses 1-4, wherein the information is obtained via a translation lookaside buffer (TLB).

Clause 6: The method of any one of Clauses 1-5, wherein the information is obtained via a data structure associated with at least one memory management unit (MMU).

Clause 7: The method of any one of Clauses 1-6, wherein the processing comprises initiating a cache flush if the information indicates a change in contents of a memory partitioning table.

Clause 8: The method of any one of Clauses 1-7, wherein: the operation involves a virtual address (VA) that maps to a physical address (PA); and the information is obtained via a table used to determine whether one or more physical address spaces (PASs) are allowed for the PA.

Clause 9: The method of Clause 8, wherein information in the table is encoded to support the plurality of external workloads.

Clause 10: The method of any one of Clauses 1-9, further comprising determining a quantity of external workloads supported.

Clause 11: The method of any one of Clauses 1-10, wherein the quantity of external workloads supported is adjustable.

Clause 12: A method by a processor, comprising: providing information indicating an operation relates to an external workload of a plurality of external workloads supported by the processor; and processing the operation in accordance with the information.

Clause 13: The method of Clause 12, wherein: the information is provided to another processor associated with a first security state; and the external workload involves access to memory associated with a second security state.

Clause 14: The method of any one of Clauses 12-13, wherein the information is provided via a plurality of physical address space (PAS) signals.

Clause 15: The method of any one of Clauses 12-14, wherein the information is provided via a plurality of bits on a bus or network on a chip (NoC).

Clause 16: The method of any one of Clauses 12-15, wherein the information is provided via a translation lookaside buffer (TLB).

Clause 17: The method of any one of Clauses 12-16, wherein the information is provided via a data structure associated with at least one memory management unit (MMU).

Clause 18: The method of any one of Clauses 12-17, wherein: the operation involves a virtual address (VA) that maps to a physical address (PA); and the information is obtained via a table used to determine whether one or more physical address spaces (PASs) are allowed for the PA.

Clause 19: The method of Clause 18, wherein information in the table is encoded to support the plurality of external workloads.

Clause 20: An apparatus, comprising: at least one memory comprising executable instructions; and at least one processor configured to execute the executable instructions and cause the apparatus to perform a method in accordance with any combination of Clauses 1-19.

Clause 21: An apparatus, comprising means for performing a method in accordance with any combination of Clauses 1-19.

Clause 22: A non-transitory computer-readable medium comprising executable instructions that, when executed by at least one processor of an apparatus, cause the apparatus to perform a method in accordance with any combination of Clauses 1-19.

Clause 23: A computer program product embodied on a computer-readable storage medium comprising code for performing a method in accordance with any combination of Clauses 1-19.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

Means for obtaining, means for processing, means for determining, and means for providing may comprise one or more processors, such as one or more of the processors described above with reference to FIG. 8.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method by a processor, comprising:
obtaining information indicating an operation relates to an external workload of a plurality of external workloads supported by the processor; and
processing the operation based on the information.

2. The method of claim 1, wherein:
the processor is associated with a first security state; and
the external workload involves access to memory associated with a second security state.

3. The method of claim 1, wherein the information is obtained via a plurality of physical address space (PAS) signals.

4. The method of claim 1, wherein the information is obtained via a plurality of bits on a bus or network on a chip (NoC).

5. The method of claim 1, wherein the information is obtained via a translation lookaside buffer (TLB).

6. The method of claim 1, wherein the information is obtained via a data structure associated with at least one memory management unit (MMU).

7. The method of claim 1, wherein the processing comprises initiating a cache flush if the information indicates a change in contents of a memory partitioning table.

8. The method of claim 1, wherein:
the operation involves a virtual address (VA) that maps to a physical address (PA); and
the information is obtained via a table used to determine whether one or more physical address spaces (PASs) are allowed for the PA.

9. The method of claim 8, wherein information in the table is encoded to support the plurality of external workloads.

10. The method of claim 1, further comprising determining a quantity of external workloads supported.

11. The method of claim 10, wherein the quantity of external workloads supported is adjustable.

12. A method by a processor, comprising:
providing information indicating an operation relates to an external workload of a plurality of external workloads supported by the processor; and
processing the operation in accordance with the information.

13. The method of claim 12, wherein:
the information is provided to another processor associated with a first security state; and
the external workload involves access to memory associated with a second security state.

14. The method of claim 12, wherein the information is provided via a plurality of physical address space (PAS) signals.

15. The method of claim 12, wherein the information is provided via a plurality of bits on a bus or network on a chip (NoC).

16. The method of claim 12, wherein the information is provided via a translation lookaside buffer (TLB).

17. The method of claim 12, wherein the information is provided via a data structure associated with at least one memory management unit (MMU).

18. The method of claim 12, wherein:
the operation involves a virtual address (VA) that maps to a physical address (PA); and
the information is obtained via a table used to determine whether one or more physical address spaces (PASs) are allowed for the PA.

19. The method of claim 18, wherein information in the table is encoded to support the plurality of external workloads.

20. An apparatus, comprising:
at least one memory comprising instructions; and
at least one processor configured to execute the instructions and cause the apparatus to:
obtain information indicating an operation relates to an external workload of a plurality of external workloads supported by the processor; and
process the operation based on the information.
